(19) United States
(12) Patent Application Publication
(10) Pub. No.: US 2015/0189243 A1
(43) Pub. Date: Jul. 2, 2015

(54) AUTOMATED VIDEO PRODUCTION SYSTEM

(71) Applicant: Telemetrio LLC, Lathrup Village, MI (US)

(72) Inventor: Marco Cucco, Lathrup Village, MI (US)

(73) Assignee: Telemetrio LLC, Lathrup Village, MI (US)

(21) Appl. No.: 14/483,184

(22) Filed: Sep. 11, 2014

Related U.S. Application Data
(60) Provisional application No. 61/921,378, filed on Dec. 27, 2013.

(51) Int. Cl. H04N 7/18; H04N 1/00; H04N 5/232; G11B 27/031; G06T 7/20

(52) U.S. Cl. CPC H04N 7/181; G11B 27/031; G06T 7/20; H04N 5/232; H04N 5/23206; H04N 1/00244; G06T 2207/10016

(57) ABSTRACT

An automated event broadcast system uses multiple cameras and a processor which tracks the action of the event and selects which camera provides the best view of the action on a continuous, live basis. The system also tracks statistics and identities of participants broadcasts both the selected best camera view and the statistics the system tracks and generates.

### CROSS-REFERENCE TO RELATED APPLICATIONS

This application claims the benefit of U.S. Provisional Application No. 61/921,378, filed Dec. 27, 2013, which is incorporated herein by reference.

### STATEMENT REGARDING FEDERALLY FUNDED RESEARCH

This invention was not made under contract with an agency of the U.S. Government, nor by any agency of the U.S. Government.

### FIELD OF THE DISCLOSURE

This disclosure relates to automated systems for acquiring and displaying video and optionally other information pertaining to events or actions occurring within a defined area or venue.

### BACKGROUND OF THE DISCLOSURE

Across the world, the number of events staged at large venues increases every year. These events take many forms such as sporting events, religious observances, musical and theatrical events.

Typical cities in the United States have approximately one recreation or sports center per 10,000 residents. A typical U.S. city has one or two skateboard parks per 100,000 residents.

From 1989 to 2009, the United States spent a total of approximately 30 billion dollars on major league sports venue construction. The amount spent on the much larger number of amateur and local sports venues is much greater.

In addition to single purpose sports venues, such as soccer clubs or city park baseball diamonds, the educational institutions in the United States add another dimension to the scope of sports venues.

Most primary education institutions (elementary, middle and high schools) have a sports venue such as a soccer field, a gymnasium, and so on. Given approximately 65,000 to 70,000 or more elementary schools and about 25,000 secondary schools, this is another indication of the large number of events and venues in the United States.

There are another 4,000 to 5,000 institutions of higher learning in the United States, having additional venues and sporting events. Some of these events are of regional or national interests, but all such events are of great local interest.

In a typical year about 24 million Americans participate on a basketball team, 22 million will participate on a football team, 18 million will participate on a baseball team, and about 13 million will play soccer (football) and volleyball.

Lacrosse draws over a million participants per year. Freestyle skiing increased almost 60% over the last three years, and most participants in outdoor activities actually participate in multiple outdoor activities.

In a typical year consumer purchases of sporting goods in the United States average around 80 billion dollars. Several billion of that is spent on athletic team goods. For example, almost half a billion dollars per year is spent on baseball equipment alone. Eighty million dollars per year is spent on soccer balls alone.

About 2,000,000 weddings per year occur in the United States, many in the approximately 70,000 churches, others in commercial wedding halls and other venues.

Interest in such events is quite high, but it is highest at the time of the event. People enjoy seeing live events occur much more than watching recordings of old events.

Most such events are recorded on video by means of a telephone, camera or mobile device (tablet, computer, smart phone, etc.), and the recording can usually be made available only after the event, when interest is lower. Streaming or sharing such events is possible but not particularly easy.

Such recordings are usually of rather low quality, as the typical viewer is not trained to recognize the individuals and lacks the resources to track action in several different places.

About 48% of respondents in a recent survey reported watching live content on television in 2013, but 53% watched with an augmented television having a set-top box. About 38% watched live content such as sports, news, etc. on a computer, 50% on a mobile device.

About 70% of social media users use the media to connect with family and friends, while 36% use social media to share media content. It is thus worth considering the prospect of allowing consumers to watch events such as sporting events, weddings, outdoor events and the like by means of social media.

Consumers would likely be interested in the option of watching, live events featuring people they know. However, this has not occurred because of the low quality of the tracking and selection carried out by most viewers of such events.

Various systems which serve somewhat different purposes and having different structures are known.

U.S. Patent Publication 2003/0179294 to Martins, published Sep. 25, 2003, tracks multiple bodies in a closed structure but never makes a connection between the locations which are tracked and any form of identity, such as a particular player, or distinguishing the ball from the player, etc.

U.S. Pat. No. 7,876,352 to Martin, patented Jan. 25, 2011, concerns databasing and association of information with a particular player.

U.S. Patent Publication No. 2009/0041298 to Sandler et al. (Feb. 12, 2009) teaches a frame (called a window, see paragraph [0080] and [0086]) which moves to follow a participant.

U.S. Patent Publication 2007/0146484 to Horton et al. (Jun. 28, 2007) teaches a multiple camera system with offset cameras as a training aide for an individual user.

### SUMMARY OF THE DISCLOSURE

Disclosed is a system and method for preparing watchable, edited video streams or recordings of events, particularly sporting events but not limited thereto, which is carried out automatically and yet provides actual tracking of action, provides statistical breakdowns of what is being seen, and can even identify participants and provide statistics or a broadcast which is tailored to that particular participant.

In certain aspects of this disclosure, a system for generating an edited video output of at least one object during an event at a venue includes a plurality of video imaging devices (e.g., cameras), each generating a video feed showing the object within the venue from a different perspective, a processor receiving the video feed and programmed to analyze and select a particular feed for video output based on at least one criterion, wherein the processor is programmed to develop statistical information pertaining to movement of the object or interactions with another object and display the statistical information in the video output.

In certain aspects of this disclosure, a method for generating a video output that displays at least one object during an event at a venue includes steps of positioning a plurality of video imaging devices within the venue to generate a plurality of video feeds from different perspectives, using a processor for receiving the video feeds and selecting a particular video feed for the video output based on at least one criterion, and using the processor to analyze the video feeds and develop statistical information pertaining to movement of the object or interaction of the object with another object, and displaying the statistical information in the video output.

The edited video streams may be provided either live or recorded for viewing at a later time. One potential embodiment can be implemented at a low cost and with great convenience to users employing a server computer available by network, which accepts submitted video and then processes the video offline and returns the edited video in a form suitable for publication, with statistics, tracking a particular player or object, such as a ball, etc.

In one aspect of this disclosure, a system includes multiple cameras, which may move or be fixed. These cameras will provide broad coverage of a venue in which an event is taking place. The coverage is not simply broadcast without further refinement. Rather, the action is continuously electronically tracked and the view provided by that camera which is best positioned is used. If cameras are able to move, then physical zoom, pan and similar effects may be provided. If the cameras are fixed then electronic zoom, pan and so on may be used instead. The system may also be set up to show multiple views of events which it has been programmed to recognize as being exciting or important, such as goals. The system can also automatically provide replays of interesting events.

The statistical modules of the system allow statistics to be accumulated for the overall event (such as minutes into a wedding, time remaining in a race or number of times the system detects the ball entering a goal) and/or individual statistics such as passes, goals by a player, time of possession, speed, etc.

The system might for example track the passage of a basketball about a basketball court or a soccer ball about a soccer field and detect the identity of the players having the ball at any one time, and the identify of players at both ends of a pass. The system might detect the entry of the basketball/soccer ball into the hoop/goal and correlate that with the identity of the player who had the ball prior to the shot, adding the appropriate points to the player's personal statistical tally.

In alternative embodiments, the system provides customized streams of video, such as to follow a particular player, rather than the moment-to-moment action of the game. A different viewer could receive a different stream to follow some other player, a particular team, the action or the action on a particular part of the field.

### BRIEF DESCRIPTION OF THE DRAWINGS

FIG. 1 is a planform view of an event venue such as a soccer (football) field, having six cameras fixed in four locations about the field.

FIG. 2 is a schematic diagram of an environment showing the cameras, server and administrative functionality, as well as the broader public networks (Internet) and devices used to access the system.

FIG. 3 is a planform view of an event venue showing dimensions and placement of a subset of the cameras showing zones of close up coverage, overlaps and relationships to goal areas, corner arcs and the like.

FIG. 4 is a transparent oblique front view of major components within the system and the coordination of geometry of the system with coverage arcs.

FIG. 5 is an oblique elevational front view of a system, showing an even lower cost version similar to that seen in FIG. 1.

FIG. 6 is a screen capture of a view showing the tracking of players, balls, referees, and even spectators as the computer analyzes the imagery and uses it to follow the action as play occurs.

FIG. 7 is a schematic view showing components and interactions within a system.

FIG. 8 is an exemplary statistical display showing one potential layout shown to a viewer of the system when they access the automated statistical database created by the system as play is happening.

FIG. 9 is a planform view of a different type of event arena, a race track, a car racing track or a go-kart racing track showing how cameras may be deployed for coverage.

FIG. 10 is a planform view of yet another type of event venue, a sanctuary, used for example for a wedding event.

FIG. 11 is a planform view of yet another type of event venue, a basketball court.

FIG. 12 is a view of a mobile device such as a smartphone, receiving an automated broadcast much like it would receive a professionally generated sports broadcast.

FIG. 13 is an oblique elevational front view of a video system for mounting on a wall, a post, a pole, or the like, and having additional cameras.

FIG. 14 is a flow chart showing a system for causing a real device to display remotely a broadcast which is being automatically generated.

FIG. 15 is a side view showing stitching of different camera views together to create a single larger or even panoramic view.

FIG. 16 is a schematic view of an Internet based embodiment of the invention which may be easy to use and implement, and may conceivably even be implemented with user cameras.

### DETAILED DESCRIPTION OF THE DISCLOSURE

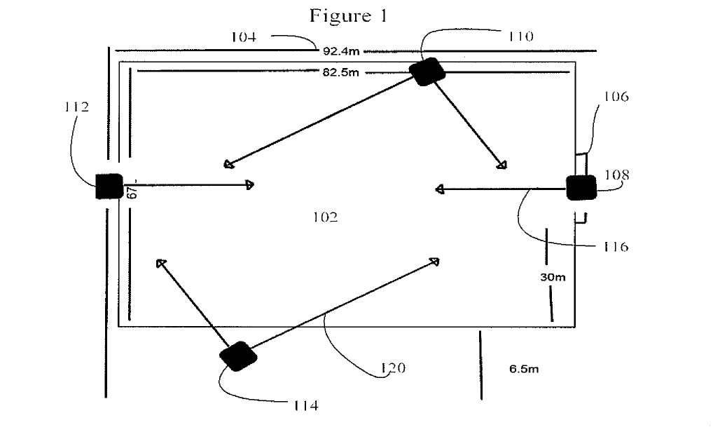

FIG. 1 is a planform view of an event venue such as a soccer (football) field, having six cameras fixed in four locations about the field. Venue 102 may be seen to have dimension 104, thus defining the area that should be covered by the cameras. Within the overall area there are some areas of greater interest, such as goal 106.

Cameras 108, 110, 112, 114 may be seen to be placed about the field. For convenience, the centerline of the cameras' field of view (such as 116) is shown. This is NOT the only direction covered by the camera, cameras are made which can cover a 170 degree arc or more, rather the arrow 116 merely indicates how the cameras are disposed.

It will be immediately obvious that the field as a whole is covered, with a bias toward coverage at closer range of areas closer to goal 106. Thus, in the area of the goals 106, there are three cameras with three different orientations set at two different locations.

As the action of the game progresses, the ball may move from being closer to camera 108 to being closer to camera 114, and the choice of camera output to be broadcast will be intelligently determined by the system tracking the ball, switching from camera to camera as the ball moves. Should a goal be scored, the net camera might be used initially (assuming it has the best view of the goal, as is likely) then the same moment might be rebroadcast in slow motion, and then the camera nearest the player automatically identified as making the shot might be used for another replay, this time beginning a few seconds earlier in order to show the player with the ball breaking free to shoot.

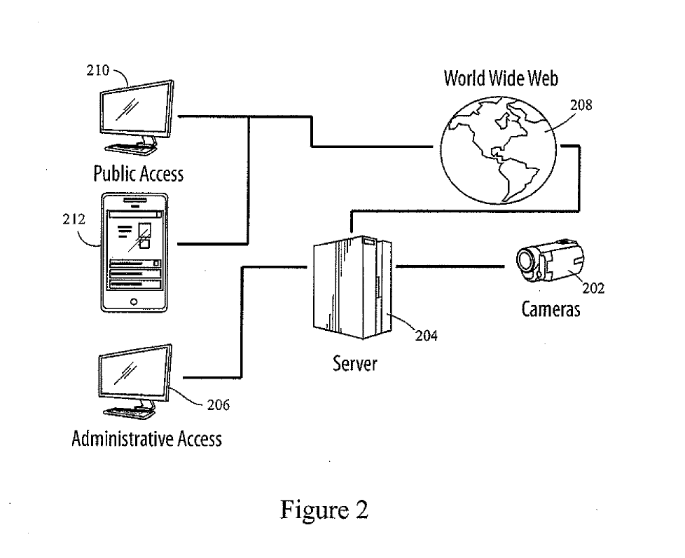

FIG. 2 is a schematic diagram of an environment showing the cameras, server and administrative functionality, as well as the broader public networks (Internet) and devices used to access the system.

Camera 202 will function independently, being able to image and transmit more or less continuously if required, however, it will also be sending output to server 204, which may in alternative embodiments actually control the operation of the camera 202, for example ordering optical (physical) zooms, pans or the like. In certain embodiments, the camera output goes to the server 204 for processing.

Administrative functionality 206 however, will provide overall control of the system, however, this control may be either during the event or in fact may be preprogrammed, even hardwired in, so that the behavior of the system is initially set and is not altered or controlled during actual broadcast. Administrative functionality obviously includes such things as start times, stop times, providing criteria to be used by the tracking and identification modules to identify objects and players and so on. For example, prior to a soccer game, an administrator might set parameters on the server 204 telling the system that it is watching a soccer match, telling it to track the soccer ball (and thus if a spectator accidentally throws a baseball onto the field, to ignore the baseball), giving it the identification criteria of players associated with their names and teams (Player number 55, “Green Dragons,” Center, age 15, name Tom Smith, no special tracking instructions) and so on. During play, the system may accumulate statistical information on the players then: time of possession, steals, passes made and received, goals and so on.

Public network 208 will in most embodiments simply be the Internet, however, it can be intranets, dedicated networks or the like.

Personal computer 210 can be used for watching of streaming content. Mobile device 212 can be used for watching streaming content. Mobile devices include phones, tablets, pads and so on.

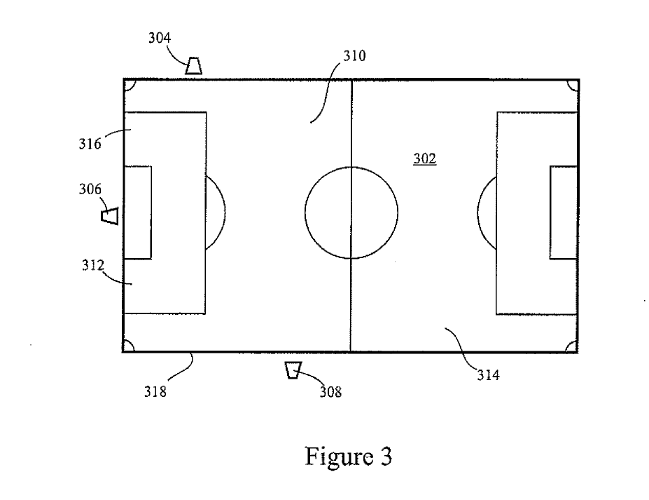

FIG. 3 is a planform view of an event venue showing dimensions and placement of a subset of the cameras showing zones of close up coverage, overlaps and relationships to goal areas, corner arcs and the like.

Venue 302 is being covered by a number of cameras. Not all of the cameras are shown, for the sake of clarity. Cameras 304, 306, and 308 may be seen however. While their fields of view are limited only by the obstructions of the venue such as walls, stands, hills, other buildings etc., the fact is that objects far from a camera do not provide exciting video. Thus, the most important single factor (there are many factors the invention may use) used in determining camera choice and viewpoint is distance from the camera. Thus, nearby field of view of camera 310 is shown. In practice, when the action of the game is in this area, this camera is preferable for use of the camera output and the server computer tracking module, which is constantly monitoring and selecting which camera to use, might be using this camera's output. Note that circumstances might alter this decision by the software: for example, a large crowd of players in front of the camera might render some other view automatically preferable.

Nearby field of view of camera 312 and nearby field of view of camera 314 show a typical advantage, and use, of the system. Overlapping nearby fields of view 316 and 318 show that in certain areas, the choice of camera may be extremely flexible.

For example, if the action is in overlapping nearby field of view 318, the tracking module might use another discriminating criteria to choose which view to broadcast.

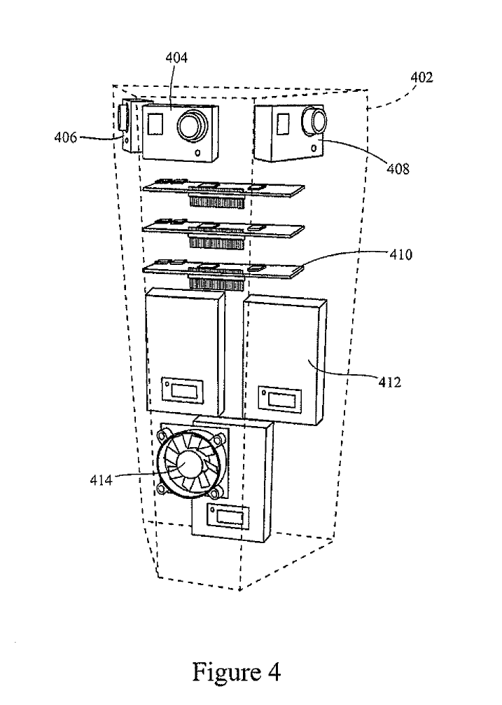

FIG. 4 is a transparent oblique front view showing major components within the system and the coordination of geometry of the system with coverage arcs.\

Sensor casing/body 402 may be a metal or polymer of low cost but high durability. It will be seen to have different faces with differing orientations, so that first camera 404, second camera 406, and third camera 408 may in turn face different directions.

Programmed PC-Interface/support equipment 410 may be PCDuino, Arduino or other similar devices (PLC controllers etc.) which will be able to handle routine communications between computers and the equipment they control.

Network module/memory 412 supports operation of the device by allowing connection to a server or local storage of video.

Support equipment/cooling fan 414 provides cool air to the equipment in the body 402, to prevent overheating, but other equipment may be used.

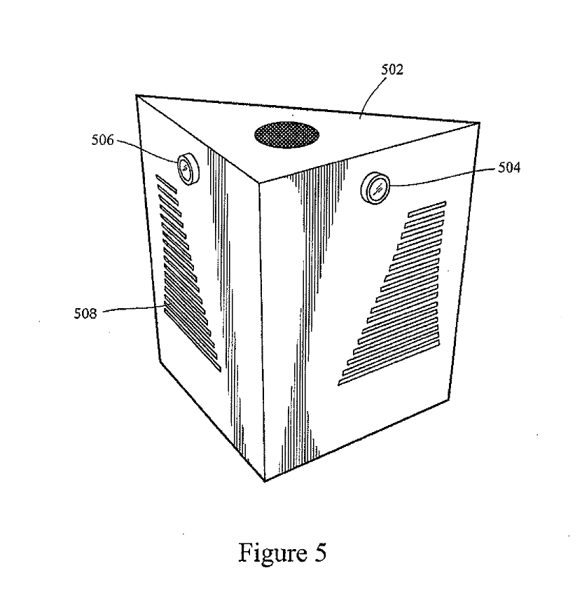

FIG. 5 is an oblique elevational front view showing an even lower cost version similar to that seen in FIG. 1.

Sensor casing 502 has first camera 504 and second camera 506 on two faces rather than on three. This embodiment reduces costs.

Support equipment 508 may be similar to what has been seen previously. Cooling slots may be used to reduce cost and weight as well.

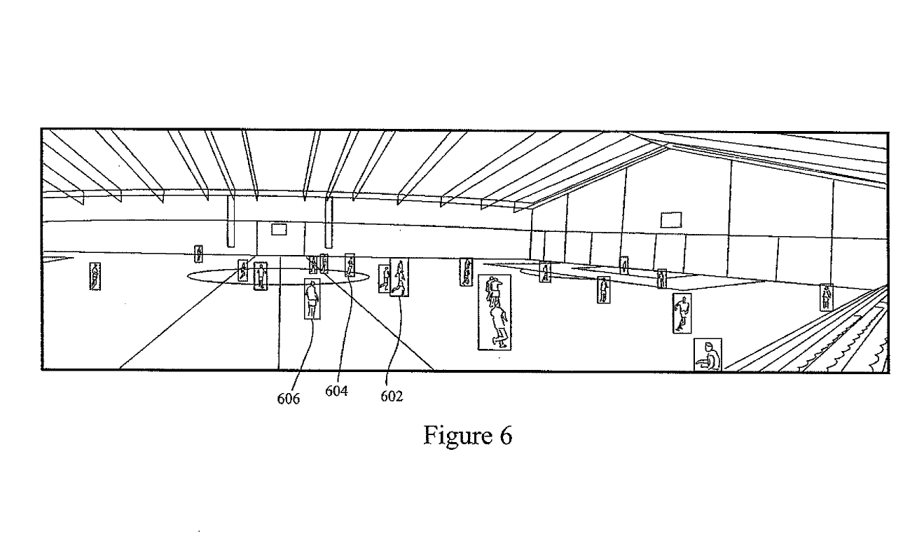

FIG. 6 is a screen capture of a view showing the tracking of players, balls, referees, and even spectators as the computer analyzes the imagery and uses it to follow the action as play occurs.

Venue (soccer field, indoor) 602 contains numerous visual objects within the camera's very wide field of view. Typical players may be seen, as may spectators, objects on the walls and so on.

Identified tracked player 604 may be identified to the system prior to the game, during the game or after the game, and may be tracked as shown by identification and tracking indicator 606 by means of visual recognition (of the jersey number), facial recognition, RFID, or other methods.

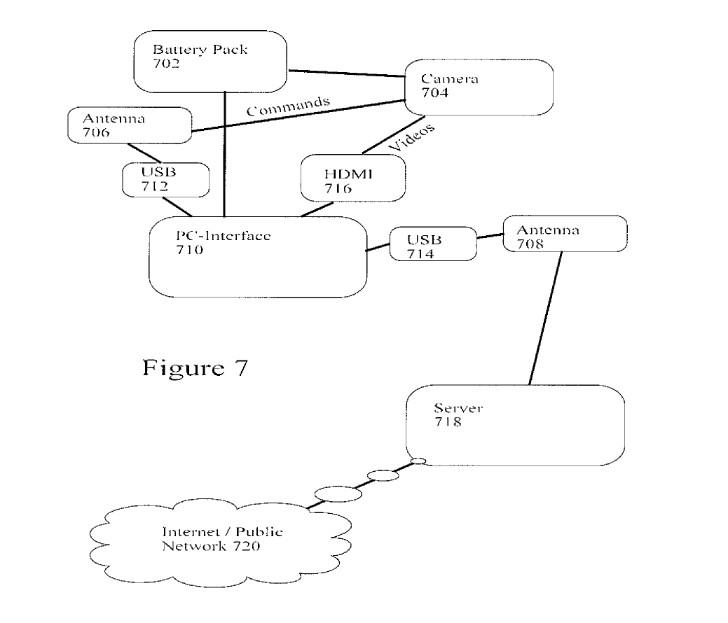

FIG. 7 is a schematic view showing components and interactions therebetween.

Battery pack 702 provides power to other components. Camera 704 is the sensor used to generate video output, which output will pass to antennas 706, 708 (which may be a single antenna in embodiments). Local system control either independent or dependent upon the server may be carried out by PC-Interface (PCDuino, Arduino, etc.) 710.

Input and output devices are used, such as USB port 712, 714 and HDMI port 716, HDMI port 716 having the advantage of being designed to handle high speed, high quality video.

Antennas 706, 708 provide a network capability, directly or indirectly, for an operative connection to server 718, which in turn connects to Internet/public network 720.

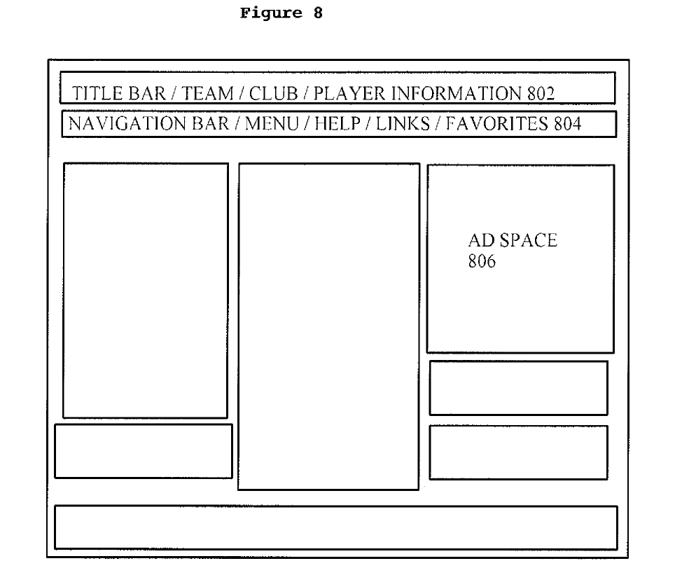

FIG. 8 is an exemplary statistical display showing one potential layout shown to a viewer of the system when they access the automated statistical database created by the system as play is happening.

Title bar 802 and navigation bar/menu bar/help/links/favorites 804 allow easy navigation and control by users. For example, one control on the menu bar 804 might allow a viewer to select which player or which team they wish to track, while title bar 802 may identify the player they are tracking.

Advertisement space 806 allows generation of revenue by the system owner: ads can be placed into the space.

Graphical representations of statistics presented 808 may be images or graphs or other method of conveying visually statistics 810 generated by the system.

Additional presentations 812, 184, 816, 818 allow flexibility in deciding what to present: the presentation 812 might be notification of another event available for watching (such as another game) or it might tell the weather and time at the location of the venue, time remaining until the World Cup finals begin, brief news items from other games being played and so on.

The types of statistics which can be used in this system are as follows: any statistics customarily generated, which can be generated automatically when tracking action, the ball, players, or participants.

Thus, using tracking technology it is possible to determine if a soccer ball goes into a net or a baseball goes out of the field of play, or if a first car passes a second car to take the lead in a car race. It is possible to track time based statistics, player and team based statistics, scoring statistics and more.

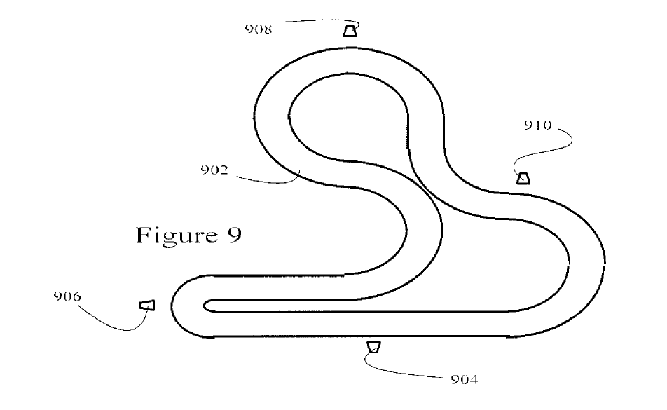

FIG. 9 is a planform view of a different type of event arena, a race track, a car racing track or a go-kart racing track showing how cameras may be deployed for coverage.

Track 902 has a winding and serpentine layout, however, most interesting action will occur at certain locations such as a straightaway or tight curves. A small number of cameras 804, 906, 908, 910 may provide excellent coverage of the race.

Since the system is automated and can use low cost fixed cameras, almost any go-kart track could provide exciting race action video to viewers.

In general, it is desirable to broadcast positive events such as winning a race, scoring a goal or the like. However, the system can also be set to flag to viewers and potential viewers when even more exciting unexpected events occur, such as car crashes, fights, and so on.

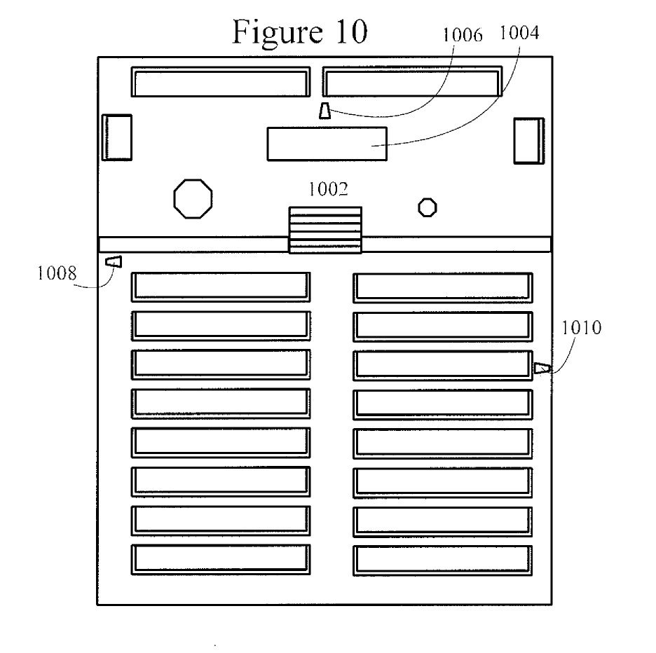

FIG. 10 is a planform view of yet another types of event venue, a sanctuary, used for example for a wedding event, showing how the system might be used to cover such an event.

Sanctuary 1002 has altar area 1004, which is analogous to area of interest 106 in that the most interesting parts of a wedding will occur there.

Cameras 1006, 1008, 1010 may be set up to cover the bride's approach down the aisle of the church, the actual moment of union at the altar and so on. By means of intelligent tracking and identification, the system can recognize, for example, the color of the bride's dress or simply the part of the church the bride should be in at any given time and broadcast accordingly.

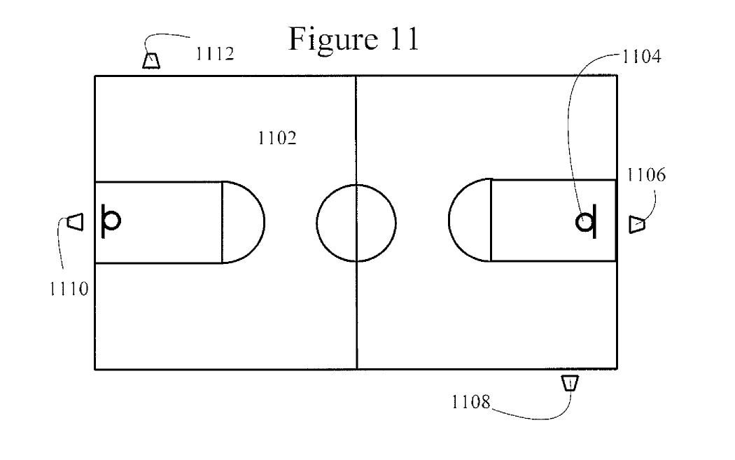

FIG. 11 is a planform view of yet another type of event venue, a basketball court, configuration to provide an automatic broadcast of the event.

Basketball court 1102 has hoop 1104 and cameras 1106, 1108, 1110, however it will be appreciated that in fact this is surprisingly similar to a soccer game in that there are goals which are areas of great interest, there are cameras which can be set up so as to provide enough coverage overall and excellent coverage of the hoops, the alley and so on.

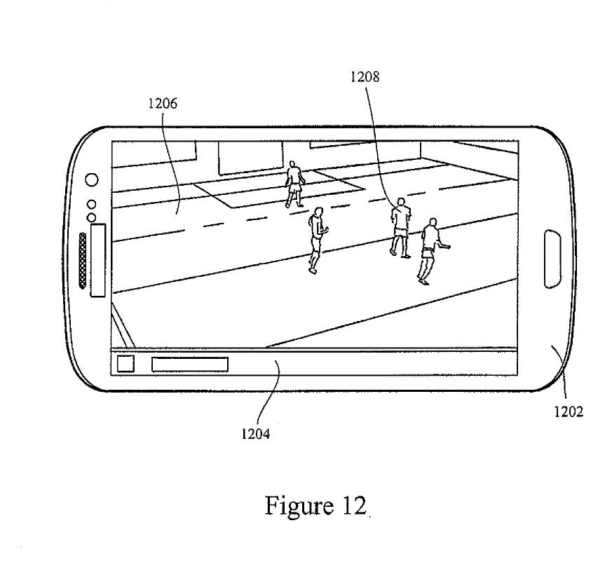

FIG. 12 is a view of a mobile device such as a smartphone, receiving the automated broadcast much like it would receive a professionally generated sports broadcast.

Mobile device 1202 may have on it video output player 1204 which is actually displaying the selected video output 1206. One advantage of the present system is that either a proprietary video player designed for optimal use of the system may be employed (for example, the video player might allow the viewer to switch their own view to one other than is being broadcast). Such a proprietary video player might even let the viewer select one particular player of interest 1208 and from then on, the viewer will always have that person in sight, even though the main streaming video is showing the action.

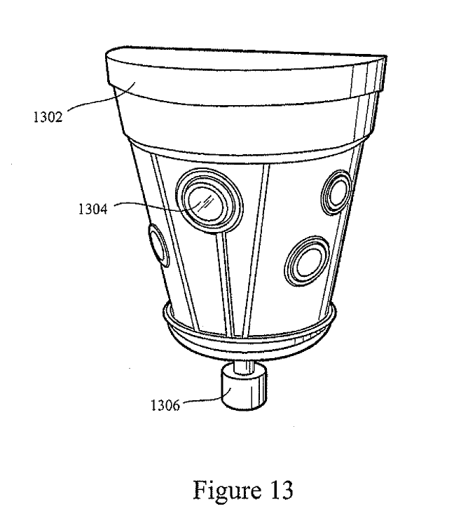

FIG. 13 is an oblique elevational front view of a system suitable for mounting on a wall, a post, a pole, or the like, and having additional cameras. Sensor casing 1302 has numerous cameras such as camera 1304. It may also have wireless network connection 1306, a connector to the support and so on.

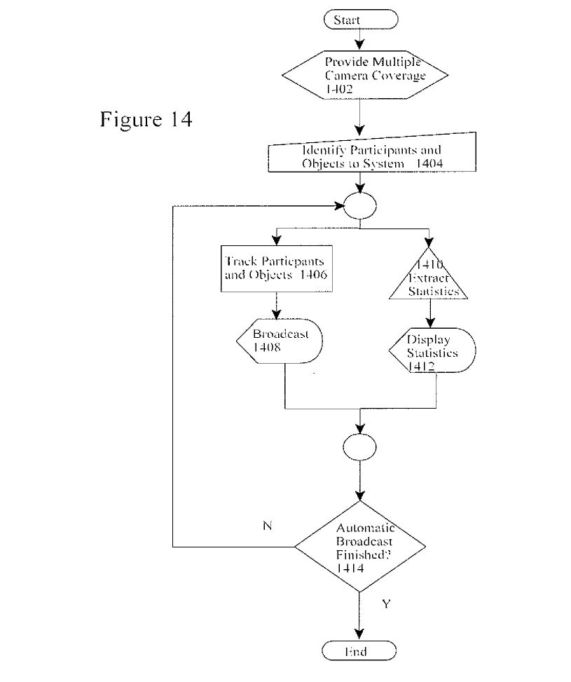

Identifying participants and object to system 1404 (FIG. 14) is a part of the process in which human input, or input from an overall system of which this system is merely a part, provides the server with the ability to identify objects such as goals, balls, bases, bats, yard markers, penalty boxes, corner arcs, hoops, altars, dresses, hockey sticks as well as the identifying criteria of individual participants. Such identifying criteria may be facial recognition, jersey number recognition, wedding dress/tuxedo recognition, body size/shape/demeanor/position, etc.

Tracking participants and objects 1406 allows the use of multiple cameras at low cast: the best available view is used and the system automatically “cuts” from video output to video output to provide a thrilling and informative broadcast, which is then in step 1408 actually broadcast/narrowcast/streamed to the Internet or an intranet or to the world at large.

Extract statistics 1410 is as described previously and we see the display of statistics at step 1412.

Continuing until the end of the broadcast 1414 may be carried out by recognition of events (whistles, departure of the bride, buzzers, etc.) or by human intervention with the system, or by timeout, etc. Note that the system can also be programmed to instantly provide and broadcast a highlight reel of a few moments in length in which the system might rebroadcast a series of short clips: the beginning of the event, highlights of the events such as goals or kisses, notable interactions in which participants suddenly depart from the normal order of play to interact with one another in unusual ways, and so on.

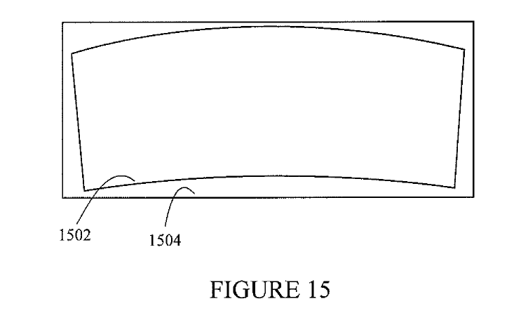

Cameras may be provided in a fixed position so that views may be stitched together to create panoramic views of the field. In operation, the location must be fixed for tracking purposes, however, the position may be changed between uses as the system can be reprogrammed. Thus, the system can be flexible enough to accommodate different types of events on the same venue, for example, a city park field which is used for baseball one day but soccer the next day. FIG. 15 is a side view showing stitching of different camera views together to create a single larger or even panoramic view. Stitched view 1502 is a composite of several camera views which would be much smaller individually. By means of stitched view 1502 a larger part of the overall background view 1504 may be covered. This helps to provide a viewer with more of the experience of really being sitting in the stands, with a panoramic view of the entire field.

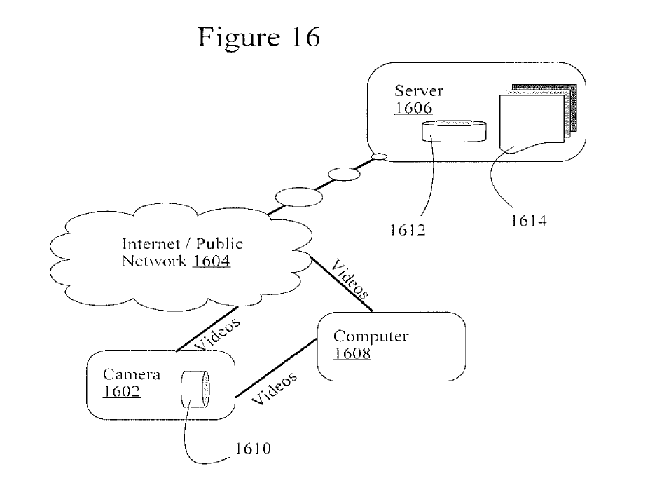

FIG. 16 is a schematic view of an Internet based system which may be easy to use and implement, and may conceivably even be implemented with user cameras.

In alternative embodiments, the system may be provided in a manner other than a live broadcast. For example, an amateur sports team or wedding planner might provide the raw footage from cameras to a service which takes the footage and automatically provides the edited version. Such a service might be in a shop or store, however it might be online, virtual or even provided by a kiosk such as a photo booth or the like. A user might take an SD card or other memory chip to a booth or machine or upload it to a site and then have it be automatically edited at low or nil human intervention. Thus, camera 1602 may be owned by the venue, such as a camera network at a sports venue or wedding hall, or even may be cameras owned by relatives of individual players, which are set up and allowed to videotape the match from different angles. Regardless of ownership of the cameras, the objective would be to provide the video telecast by means of batch processing rather than as a live feed.

For this reason, after the match/event had concluded users would access network 1604 for an equivalent kiosk or the like) and by means of network 1604 in turn access server 1606. As previously mentioned, server 1606 will have thereon modules 1614, such as those modules discussed previously.

Computer 1608 may be an intermediary between the camera 1602 and the network 1604, however, as devices become more connected the camera might access the network directly. As an example, many mobile telephones already have cameras with excellent resolutions such as 31 Megapixels or more, and also have the ability to access various networks such as cell telephone networks, the Internet, intranets, WiFi and Bluetooth based networks and so on.

Solid State Memory 1610 is presently preferred for affixing videos into most cameras while hard disk 1612 is preferred for most computers and servers. Modules 1614 and video may both reside in memory, regardless of the type of the memory, and thereafter may display/return/narrowcast/post/publish electronically or physically the edited video.

The disclosed video systems may also have a website or tool embodiment which is a desktop with widgets, meaning tools which can be invoked, deleted, managed, etc. By this means, a viewer might later access the event files and have the system narrowcast a viewpoint designed for a single person's tastes: a view of a single player for the entire game, a view of the groom's part of a wedding, etc. Advertisers might sponsor a widget or something similar. The website can be managed so that depending upon the identity of the user, certain elements (widgets/capabilities) may be enabled, disabled, or omitted.

In this embodiment, the step of identifying players to the system may be undertaken by individual players entering the system, and the identification can be done by clicking a photograph. This system may be entirely cloud based without necessity to install a client side application.

A further detailed view of the system may be provided by the following insertion to this application, which appendix comes from development planning.

Players can benefit a lot from a consistent and well built set of statistics from each game, players speed, touches, goals, and any other information is useful to evaluate a player performance for team improvement and coaching or by plain fun watching each player's performance, best plays, etc. This would be only possible in large scale if an automatic system records the game and generates this information without human intervention, specifically a computer vision system (CVS).

The system projected to perform this task may be composed to 3 main modules: A computer vision module takes care of capturing the entire field with one or multiple digital cameras and process the videos to individually track each object in the field (players and ball) dealing with common problems that might be present in changing external conditions. The tracked objects are stored in a simple and clean way as raw data (object label and relative position in the field) in a database. An information generation and storing module allows statistics to be extracted from object records stored in the database. Each statistic follows a discreet logic and is generated by reading the records of each player on game and the ball and perform mathematical operations between this records and/or other objects records from the same game. The generated statistics are stored in the database for each particular game.

An output model presents the statistics to be shown in a visually appealing interface and in creative ways to give the user the best way to observe their performance in the game.

The system may be called from an external system that records the videos and generates the video files in any format (for example .mp4 or .avi).

The system may then process the videos and store the statistics of the video in the database returning a unique code that identifies the set of statistics generated for each event.

For some versions and embodiments of the system, there will not be any recording of the video directly from the hardware and there will not be a connection to the schedule API from the arena.

The finished system created might be for example a Linus/Unix executable that can be called from the command line.

The software parameters are entered in the command line in order to tune different aspects of the system that cannot be automated at this point (e.g. location of the videos to process). The command line interface may follow the usual Linux/Unix style e.g

$ ./bin/process-videos arg1 arg2 arg3 arg4 [-options]

Where “-options” is a list of options c.f. linus command “cp-r”, “-r” being the option

The software can then be called from any other language as command option, for example for PHP the executable can be called as follows:

$cmd=”./bin/process-video arg1 arg2 areg3 arg4 -options”:
exec ( $cmd. $output, $return );
If ( $return !=0 ):
//executed without error
}

Arguments are most likely to be location of video files, e.g. if a game has been recorded with 3 cameras then the system should receive as parameter the location of the 3 video files for that particular game.

The system could accept the input of 2 or 3 cameras in a fixed position and angle. The system might be hardcoded to accept the configuration (position and angle) of the cameras considering that the configuration of the hardware cameras might never change (the cameras might be placed inside a case or protector so they may be fixed one in respect to the other in angle and position).

The stitched image generated from merging the frames may depend on the actual configuration of the camera, so the final output video might be a curved video over a square container, as it shows in FIG. 15.

Some versions of the system might not consider cameras that are positioned in opposite angles of the field. The logical grid fitted with the actual field dimensions may help the system calculate the position, speed and everything related to the statistics generation.

The system might calibrate the FLG with the use of a manual input of the field dimensions. The user might then input the dimensions for the field to calibrate and the 4 coordinates of the field in the stitched image directly on code. For some embodiments, this probably might be the best option to calibrate the grid, and it may be with an interactive interface.

The system may also need the input of the goal post position for both sides of the field, this can be deduced from the field size but this would only work for official size fields. In football arenas, the size of the goal area varies greatly.

The FLG may be outputted in a sample video only for demonstrative purposes: in the system this grid may only aid performing mathematical tasks. The dimensions and distribution of the grid may depend on the arrangement of the cameras used.

The FLG also helps calculating when the ball enters the goal area; a player enters or exits the field. For future releases this can be used also as a retroactive tool to find out if the referee made mistakes, in goals (if the ball entered or not the goal area) of in off sides, etc.

An example of how the FLG may be plotted over the actual feed of the football field might be a square grid on the video representation of the field. The FLG may give reference in position of all objects that are moving over it.

The objects in the field are recorded with their current location (a much accurate grid might be actually calculated; probably each square may have around 30 cm×30 cm in the field. This may allow capturing all movements and does not lose details while maintaining a low complexity. This same output may be generated to access the correctness of the FLG calibration.

The system may track and record the position of the players in both teams. The system may track and record the position of the ball in the field. The system may not consider nor may be bound to any specific ball color, player, clothing color, or any number or identifiers. The system might cover as much of the field as practical in embodiments.

The tracking may generate a visual output that is a squared figure over each tracked object with their label and average speed on top of the square.

The system may not automatically associate players to their records in the field. A manual association may be done for each player to the label created by the system. All objects present in the field (moving objects) that are inside the FLG are recorded. The logic to discard objects that are not the players or the ball may be implemented in the statistics module.

The tracking may generate a visual output for accuracy and false rate detection assessment. The output may look similar to the image below where only one object is tagged. The label may contain the object label and the average speed of the player. The tracking may be recorded in the database and associated to a specific field and game.

The statistics module may take care of generating all the information from the raw video data and the tracked objects in the field. Each statistic may be explained in detail as for its significance and the way it may be outputted by the system. Statistics are generated when the system recognizes that a game has begun. It may output a numeric value of the date—hour/minute/second that represents the start of the game. The system may recognize when the game ends and generate a timestamp in the same way as the “beginning of the game” statistic.

Goals can be detected as the ball crosses the goal area or by associated logic such as when all players return to their field side after the goal (as football rules state). This specific statistic may be also recorded and outputted to video on a periodic basis (e.g. every 15 seconds).

Corner kicks can be recognized when the ball is in a fixed position (for a few seconds) in one of the corners of the field. This statistic generates a goal numeric value (corner kicks per game) and a specific number for each team stored in the database.

Average time defend vs. average time attacking may be associated to the time a majority part of the team players spent on the opposite field (attacking) and the average time the majority of the players spent on their field (defending). Stored as numeric value for each time in the database.

The speed parameter may be calculated for each object (all players and ball individually), the average speed for the team is the weighted average of all the players speed in the field (except for the goal keeper). And the average game speed is the weighted average of the speed of all players without the goal keepers. Also outputted as independent numeric values and stored in the database.

Touches defined as the interaction between the ball and any of the players, each time the ball interacts (area intersection with change of direction) with a player, is recorded in the database as a numeric value. The system may store this value for each player individually and it can be grouped as touches per player, per team and per game. Goal keeper saves are the interaction of the goal keeper with the ball if the ball projected trajectory (rect line from origin) ends inside the goal area. If this interaction does not end with the ball inside the goal area then a “goal keeper save” is stored in the database as numeric value for both teams independently.

The speed of the ball of specific portions of the game and for specific associated objects, for example a kick from a player and the goals speed, may be recorded. The time that players and the ball are in specific portions of the field can be determined. A number of fields may be considered, areas, middle field and corner sides to generate this statistic.

Balls lost and won may be measured as the interaction of the ball between one player of one team and one player of the other team, if a player from a team kicks the ball and the next recorded interaction for the ball is from the member of the other team a loss of ball has occurred for one team and a win for the other team. The statistics and all the generated information may be stored in a relational database. This database may contain all the raw information of the videos for a game and the statistics generated for each particular game.

The outputs of the system are the sole products generated during the processing of the information; this outputs consist in 4 specific products. The system may generate a video sample of the entire game with the player's marked (squared marker) and the ball (round marker) and their labels placed over each square along with their average speed. The system may also output a single video file of a specified duration (e.g., 30 seconds) for each goal in the game (15 seconds previous to the goal and 15 seconds after the goal). The system may output the statistics file containing all the statistics in a plain text format. The system may return to the caller (when the system is called by an external api) a numerical code. This code can be used to extract the statistical information directly from the database.

Sensors (in addition to cameras) can be incorporated into the systems and methods disclosed herein. For example, players participating in a game that is being video recorded, broadcast or streamed can be provided with sensors for measuring their heart rate, temperature, respiration rate, perspiration, position, velocity and acceleration. Such information, along with the identity of the player, can be communicated to the system processor via telemetry and inserted into the video output in a predetermined way (e.g., periodic overlays that rotate through the list of players) or in a user defined way (e.g., always showing information for a particular player).

Multiple processors can be used to perform the various processor tasks or functions disclosed herein. Such processor or processors can be located at or near the venue or can be located remotely from the venue, such as at a central facility that stores, serves and/or broadcasts the video outputs. Certain tasks can be performed by a local processor (e.g., located at the venue), while other tasks can be performed by a remotely located processor.

The systems and methods disclosed herein can be modified and adapted for other uses, such as controlling irrigation systems on golf courses without interfering with play, monitoring livestock, security and surveillance.

This disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

1. A system for generating a video output that displays at least one object during an event at a venue, comprising:
a plurality of video imaging devices, each video imaging device positioned to generate a video feed showing the object within the venue from a different perspective;
a first processor receiving the plurality of video feeds from the video imaging devices, the processor programmed to select a particular feed for the video output based on at least one criterion; and
the first processor or a second processor programmed to analyze the video feeds and develop statistical information pertaining to movement of the object or interaction with another object, and to display the statistical information textually or graphically as an overlay or insert on the video output.

2. The system of claim 1, in which at least one of the video imaging devices is capable of panning, tilting and/or being translationally moved, and at least one of the first processor, the second processor, and a third processor is programmed to control the panning, tilting and/or translational movement based on the at least one criterion or on at least a second criterion.

3. The system of claim 1, in which the criterion is a default criterion.

4. The system of claim 1, in which the criterion is selected by a user via a user interface.

5. The system of claim 1, further comprising a server having an operative connection to the Internet.

6. The system of claim 2, in which at least one of the first, second and third processors, and a fourth processor is programmed to insert advertisements into the video output.

7. The system of claim 6, in which at least one of the first, second, third and fourth processors, and a fifth processor is programmed to combine two or more of the video feeds from the video imaging devices into a composite video output.

8. The system of claim 1, further comprising at least one object or venue condition sensor that provides information that is textually or graphically overlayed or inserted into the video output.

9. The system of claim 7, in which at least one of the first through fifth processors and a sixth processor is programmed to track the at least one object and control a combination of panning, tilting, and translational movement in response to movement of the at least one object in the venue.

10. The system of claim 1, further comprising a microphone at the venue, which is used to provide audio output to accompany the video output.

11. A method for generating a video output that displays at least one object during an event at a venue, comprising:
positioning a plurality of video imaging devices within the venue to generate a plurality of video feeds from different perspectives;
using a first processor for receiving the plurality of video feeds from the video imaging devices, and selecting a particular video feed for the video output based on at least one criterion;
using the first processor or a second processor to analyze the video feeds and develop statistical information pertaining to movement of the object or interaction with another object; and
displaying the statistical information textually or graphically as an overlay or insert on the video output.

12. The method of claim 11, in which at least one of the video imaging devices is capable of panning, tilting and/or being translationally moved, and at least one of the first and second processors, and a third processor is programmed to control the panning, tilting and/or translational movement based on the at least one criterion or on at least a second criterion.

13. The method of claim 11, in which the criterion is a default criterion.

14. The method of claim 11, in which the criterion is selected by a user via a user interface.

15. The method of claim 11, further comprising a server having an operative connection to the Internet.

16. The method of claim 12, in which at least one of the first through third processors and a fourth processor is programmed to insert advertisements into the video output.

17. The method of claim 16, in which at least one of the first through fourth processors and a fifth processor is programmed to combine two or more of the video feeds from the video imaging devices into a composite video output.

18. The method of claim 11, further comprising graphically or textually overlaying or inserting information from an object or venue condition sensor onto the video output.

19. The method of claim 18, in which the information is selected from a heart rate, perspiration, respiration rate, venue temperature, venue windspeed, and venue wind direction.

20. The method of claim 11, in which audio feed from a microphone at the venue is appended to the video output.

21. The method of claim 12, in which the processor is programmed to track the at least one object and control a combination of panning, tilting, and translational movement in response to movement of the at least one object in the venue.
